(19) United States
(12) Patent Application Publication
(10) Pub. No.: US 2025/0375702 A1
(43) Pub. Date: Dec. 11, 2025

(54) SELF-ASSEMBLING GEOMETRIC NETWORKS

(71) Applicant: Controlled Protocols, Inc., Mineola, NY (US)

(72) Inventor: Ralph J. COVELLI, Westbury, NY (US)

(21) Appl. No.: 18/737,169

(22) Filed: Jun. 7, 2024

(51) Int. Cl. A63F 13/352

(52) U.S. Cl. CPC A63F 13/352

(57) ABSTRACT

A game network system having server interconnection structures and convergence algorithms for homogeneous n-dimensional integral coordinate summary address networks. A multidimensional area is defined with an integral coordinate system. Blocks of space are defined within the area with coordinate summary addresses. The coordinate summary addresses are mapped to server addresses so that different blocks of space can be independently stored on different servers. A tracker is used to coordinate the server to server connectivity. The network will attempt self-assembly as long as it is not in a converged state.

### BACKGROUND OF THE INVENTION

### 1. Field of the Invention

The invention relates to a self-assembling geometric network. More particularly, a network which provides a Homogeneous Coordinate Summary Network Structure.

### 2. The Prior Art

Online virtual environment games allow multiple players, or avatars, to independently traverse from one location to another. Distributed network architecture provides one area server for each location.

For example, U.S. Pat. No. 7,904,577 shows area servers 22, 24 and 26 in FIG. 1. The Area server group 20 is connected to the world network 12 via world LAN 14. Each area server is programmed within each world server complex to govern and administer a particular geographic or physical area within the virtual reality world. As such, the world servers' administration of an avatar's interaction with the world would be shifted from one world to another as the avatar moves from one geographic area within the virtual reality world to another.

Once the login and software update processes are completed, the computer 81 will display the player's avatar within one of the virtual reality worlds 8-10 . One of the area servers 22-26 in area server group 20 will be active and operating for the benefit of a player to provide an appropriate “look and feel” in that particular geographic area. As the player's avatar transverses from one geographic area administered by one of the area servers 22-26 into another geographic area administered by another area server 22-26, the game system software transfers the control of the virtual reality presentation between the servers. As the avatars move about the particular virtual reality world and perform various tasks within that world, central world server 15 administers the overall operation of the game, including the presentation of tasks and the events that transpire asynchronous to the player's input, among various other game enhancing functions.

This type of distributed network architecture suffers from several drawbacks. It is difficult to scale the game since all new environments, and their area servers, must be registered with the central world server. When many players are in one location, the corresponding area server can become overloaded and slow down. When many players are moving from one location to another, the central world server can become overloaded and slow down.

Accordingly, it would be desirable to provide a virtual game environment that can be easily scaled and allows more streamlined movement between locations and reduced administrative load when players are handed off from one server to the next.

### SUMMARY OF THE INVENTION

It is an object of the invention to provide protocols and structures for the creation and efficient management of a distributed geometric network.

It is a further object to distribute continuous volumes of space across multiple servers seamlessly.

It is another object to provide a distributed geometric which can be readily scaled by adding serves which are spatially distributed.

It is a further object to map area server position coordinates to Internet Protocol (IP) Addresses and ports to provide direct addressing to spatially-distributed area servers.

These and other related objects are achieved according to an embodiment of the invention by a virtual environment game network system including area servers, a tracker, a global communications system and software. The tracker has a table of area servers expressed as coordinate network addresses which map to internet IP addresses. The global communications system allows the area servers and the tracker to communicate with each other. The software is embodied in a non-transitory computer readable medium including a program of instructions for assembling the area servers into a seamless virtual game environment. The program of instructions when executed by a computer performs the following steps. First, connecting the area servers to the tracker over the global communications system. Second, determining the connectivity status of the area servers to identify accessible area servers. And, third, convergence sequencing one of the accessible area servers to assemble its portion of the virtual environment adjacent to a neighboring portion of the virtual environment stored on another one of the accessible area servers thereby providing a homogeneous coordinate network to seamlessly access any coordinate address within the converged virtual environment.

The convergence sequencing step includes providing a homogeneous coordinate network to seamlessly access any previously sequenced coordinate address within the converged virtual environment. The coordinate network address includes X, Y, Z three-axis position coordinates that specify a location within the neighboring portion and a coordinate network summary address containing the position coordinates bit-shifted by the corresponding axis integer length minus the width of the network coordinate address.

The determining step includes identifying area servers that have coordinate network summary addresses that vary by one bit in one axis thereby sequencing the area servers for adjacent pairing in the convergence sequencing step. Each area server has a neighbor table including an identification of other area servers that have coordinate network summary addresses that vary by one bit in one axis thereby defining a neighboring area server and a pointer to a socket that contains network reachability information for accessing neighboring area servers. The determining step further includes determining by the tracker the connectivity status of the area servers to identify accessible area servers to populate the table of area servers.

The tracker extracts from the table of area servers and communicates to each area server an identification of other area servers that have coordinate network summary addresses that vary by one bit in one axis. The tracker maps area server position coordinates to Internet Protocol (IP) Addresses and ports to provide direct addressing to spatially-distributed area servers.

The determining step includes assigning a negative connectivity status to an area server if its coordinate network summary address is already in use by an assembled area server. Wherein, determining the connectivity status of an area server includes requesting a port from a neighboring area server. The determining step includes assigning a negative connectivity status to an area server if a neighboring area server denies a port request.

The convergence sequenced area server is a Neighboring Area Server and a divergence sequenced area server is a Connecting Area Server. The tracker coordinates convergence sequencing of the Connecting Area Server to the Neighboring Area Server.

The connecting step includes having the tracker communicate its IP Port to a Connecting Area Server (S1:2), and the Connecting Area Server responding with its coordinate network summary address, IP Address and port numbers (S1:3). The connecting step further includes having the tracker sending an Open Port Request to the Neighboring Area Server including the Connecting Area Server's coordinate network summary address, IP Address and port numbers. The Connecting Area Server's coordinate network summary address is used to determine the position in the Neighboring Server's internal socket table (S1:5). The Neighboring Server honors the Open Port Request and responds with an Open Port Acknowledgment containing the Connecting Area Server's coordinate network summary address, IP address and port numbers (S1:7). The tracker replies to the Neighboring Area Server by sending a Connect Request to the Connecting Area Server containing the Neighboring Area Server's coordinate network summary address, IP address and port numbers (S1:8).

The convergence sequencing step includes having the Connecting Area Server send a Server Statement to the Neighboring Area Server containing the Connecting Area Server's coordinate network summary address, IP address and port numbers (S1:10). The Connecting Area Server sends a Connection Acknowledgment to the tracker containing the Neighboring Area Server's coordinate network summary address, IP address and port numbers (S1:11). The Connecting Area Server sends a Server Statement to its Local Clients containing the Neighboring Area Server's coordinate network summary address, IP address and port numbers (S1:12). The Neighboring Area Server responds to the Connecting Area Server's Server Statement with a Server Acknowledgment containing the Neighboring Area Server's coordinate network summary address, IP address and port numbers (S1:13).

The convergence sequencing step further includes having the Neighboring Area Server send a Connected Statement to the tracker containing the Connecting Area Server's coordinate network summary address, IP address and port numbers (S1:14). Next, having the Neighboring Area Server send a Server Statement to its Local Clients containing the Connecting Area Server's coordinate network summary address, IP address and port numbers (S1:15). And subsequently, having the Connecting Area Server respond to the Neighboring Area Server's Server Acknowledgment by sending a Connected Statement to the tracker containing the Neighboring Area Server's coordinate network summary address, IP address and port numbers (S1:16).

The disconnecting step includes having the Disconnecting Area Server disconnect from the tracker (S2:2). Next, having the Disconnecting Area Server communicating the failure to the Neighboring Area Servers by sending a Tracker Failure Statement (S2:3). The tracker responds to the Disconnecting Area Server by sending the Neighboring Area Servers a Delete Server Statement (S2:4). The Disconnecting Area Server disconnects the Neighboring Area Servers (S2:5). The area servers all store neighboring portions of the same size.

### BRIEF DESCRIPTION OF THE DRAWINGS

The patent or application file contains at least one drawing executed in color. Copies of this patent or patent application publication with color drawings will be provided by the Office upon request and payment of the necessary fee.

The advantages, nature, and various additional features of the invention will appear more fully upon consideration of the illustrative embodiments now to be described in detail in connection with accompanying drawings. In the drawings wherein like reference numerals denote similar components throughout the document.

FIG. 1a is an overview chart showing the communication paths between the lattice servers and the other components of the invention.

FIG. 2a is a diagram showing how to resolve a position to a Summary Address Coordinate.

FIG. 2b is a diagram showing various states of the lattice network structure.

FIG. 2c is a diagram illustrating a lattice network with a hollow center.

FIG. 3a is a flowchart showing the server to tracker network convergence steps from the connecting server's point of view.

FIG. 3b is a flowchart showing the server to tracker network convergence steps from the receiving server's point of view.

FIG. 3c is a flowchart showing the server-to-server network convergence steps from the tracker's point of view.

FIG. 4a is a diagram showing how the tracker initiates convergence of server H.

FIG. 4b is a diagram showing how the tracker informs the neighboring servers of the impending convergence of server H.

FIG. 4c is a diagram showing how the server H is fully converged.

FIG. 5a is a diagram showing how the tracker initiates divergence of server H.

FIG. 5b is a diagram showing how the tracker informs the neighboring servers of the impending divergence of server H.

FIG. 5c is a diagram showing how the server H is fully diverged.

FIG. 6a is a chart showing the tracker and server instructions during convergence.

FIG. 6b is a chart showing the tracker and server instructions during divergence.

FIG. 7 is a diagram showing an example of server coordinates in various locations within the game.

### DETAILED DESCRIPTION OF THE PREFERRED EMBODIMENTS

### Theory of Operation

These and other related objects are provided by a network that includes area servers, a tracker and convergence sequences initiated by the servers and influenced by their locations. The tracker holds a global table of servers. It maps server coordinates to server IP addresses and port numbers. Its main purpose is to coordinate server to server connectivity.

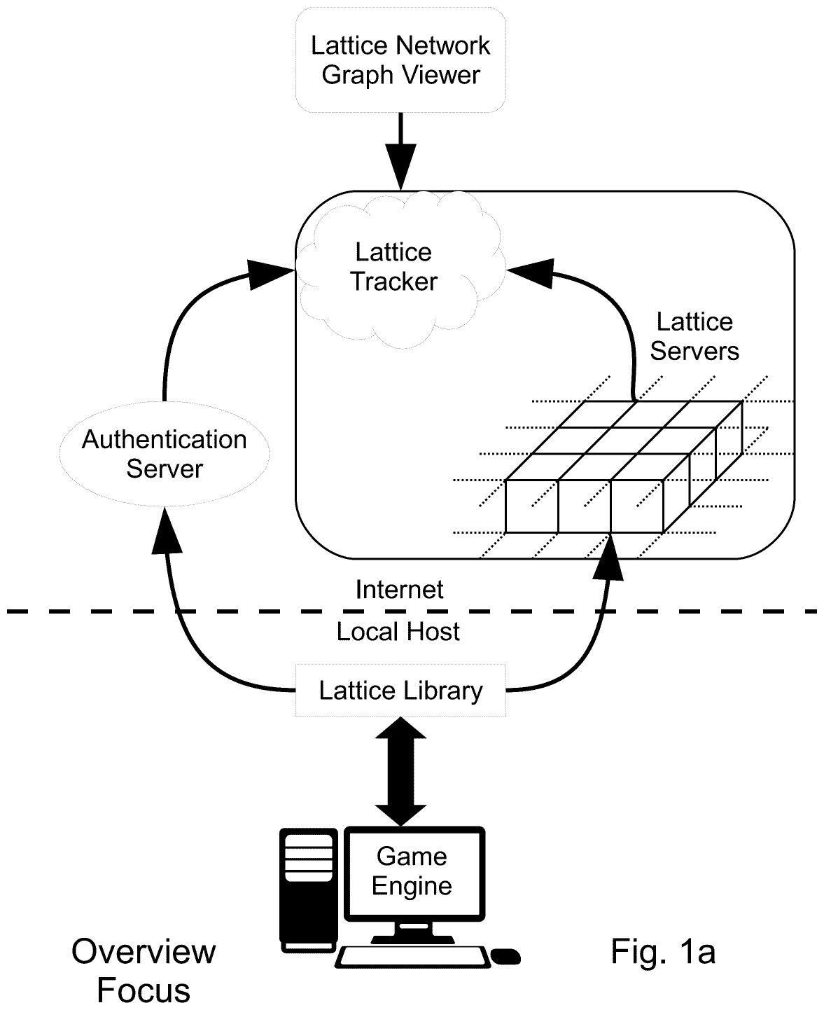

FIG. 1a shows the overview focus of this invention. The invention is concerned with the communications of servers to trackers and servers to other servers. Outside the focus of this invention, is the local computer with the game engine shown on the bottom of the diagram. The game engine uses a lattice library module to communicate with the authentication and lattice servers on the Internet. The authentication server and graphing viewer also communicate with the tracker. These features are outside the scope of the present invention.

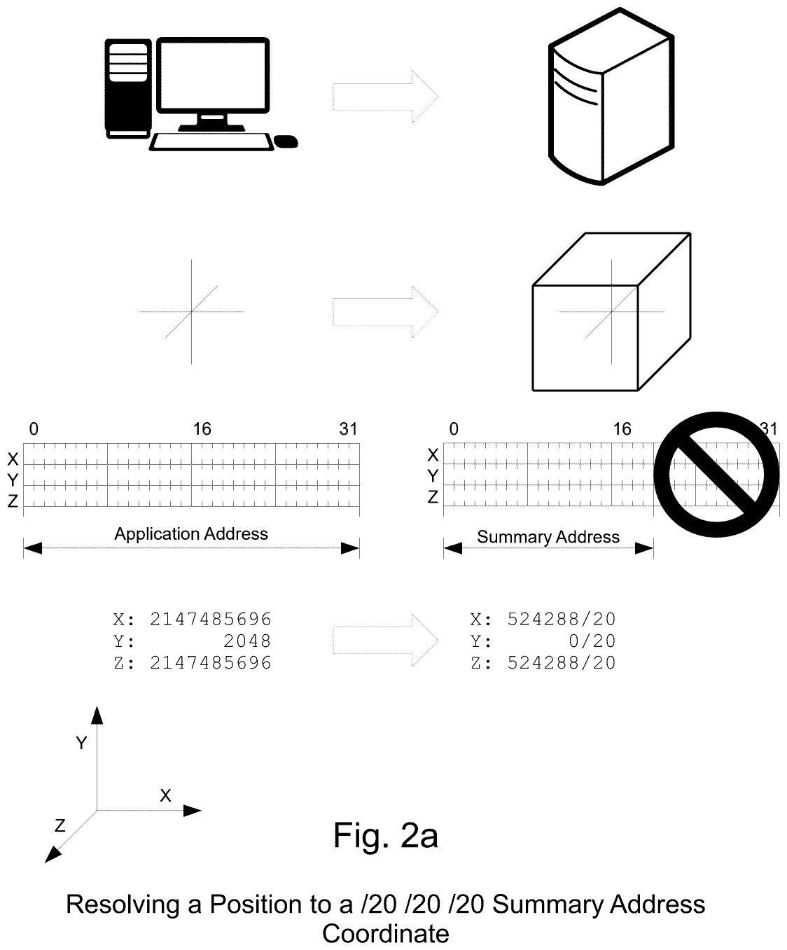

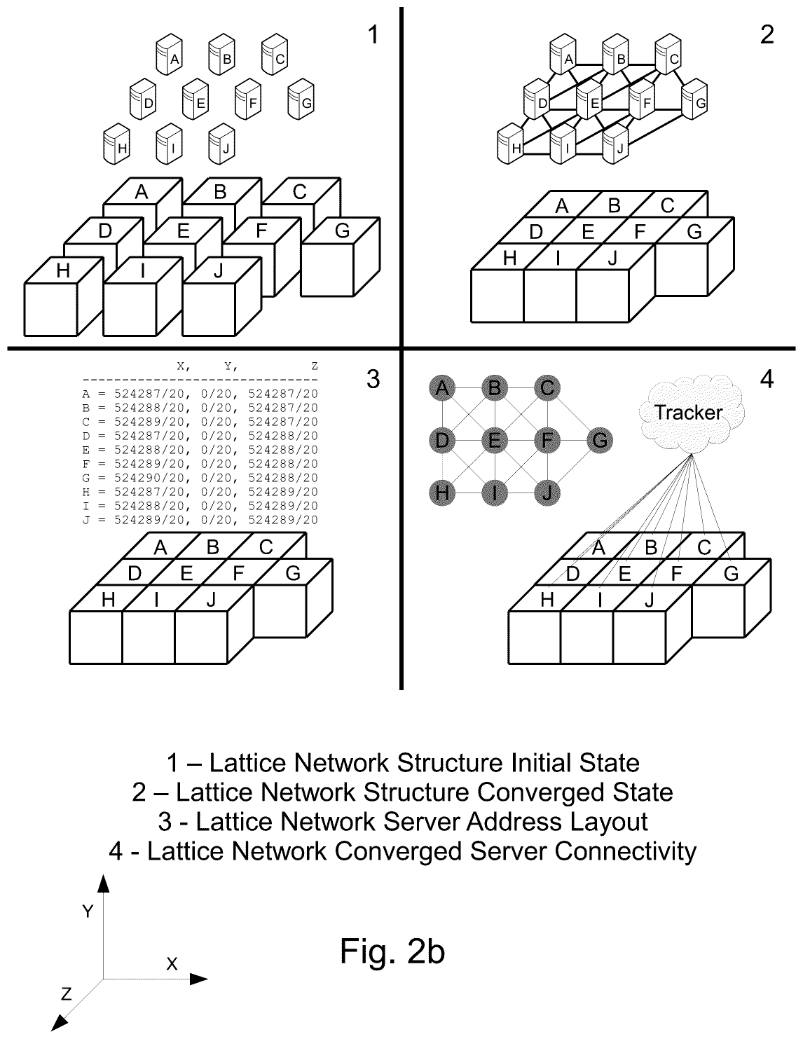

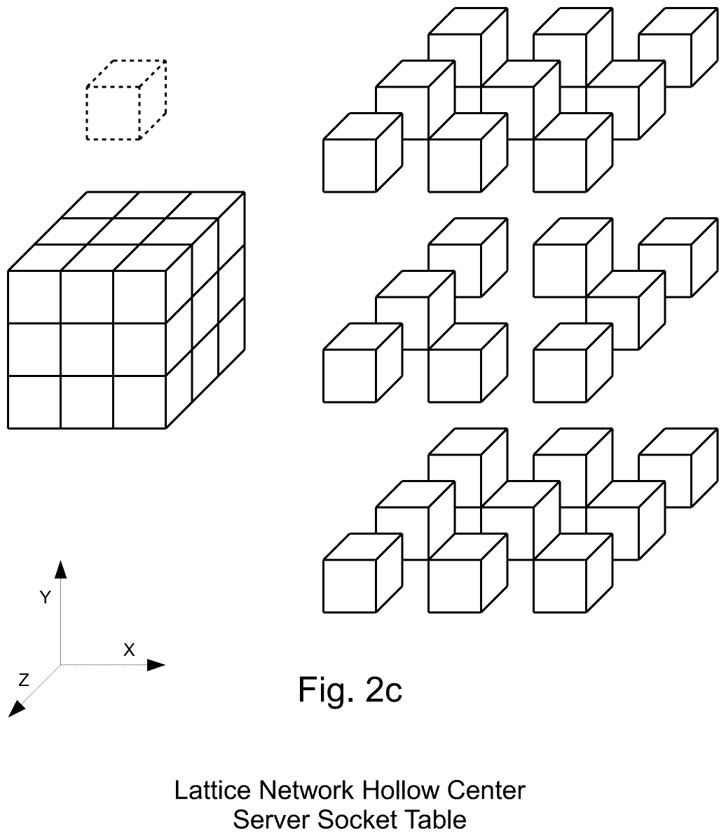

FIG. 2a shows how in-game player coordinate positions are used to determine which lattice server the player is standing on (or otherwise occupying).

FIG. 2b is divided into 4 sections. Section 1 is depicting a completely disconnected network. In this state the servers are all independent. Section 2 is depicting a network that has been converged and is fully connected. In this state players can freely walk between servers. Section 3 is depicting the server addresses numerically and visually. Section 4 is depicting server to tracker connectivity and server to server connectivity in a converged state.

FIG. 2c visually depicts the 3 dimensional socket table that each server has and uses to communicate with their adjacent neighbors. The socket table effectively maps the direction to the neighbor's IP address.

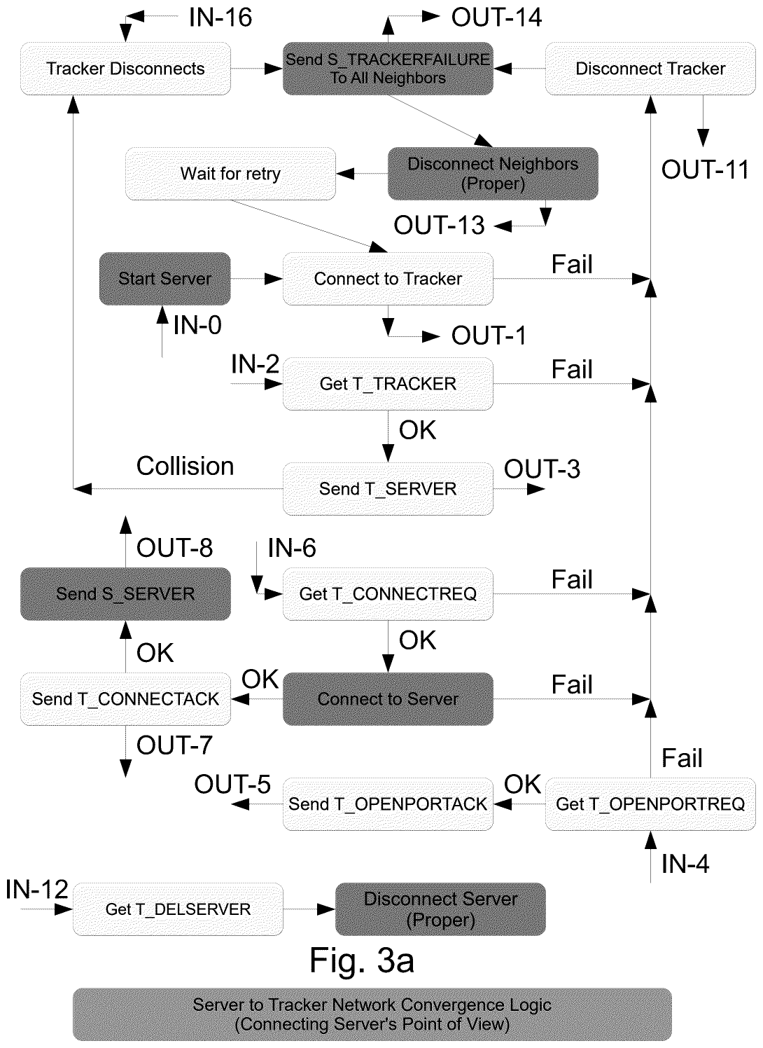

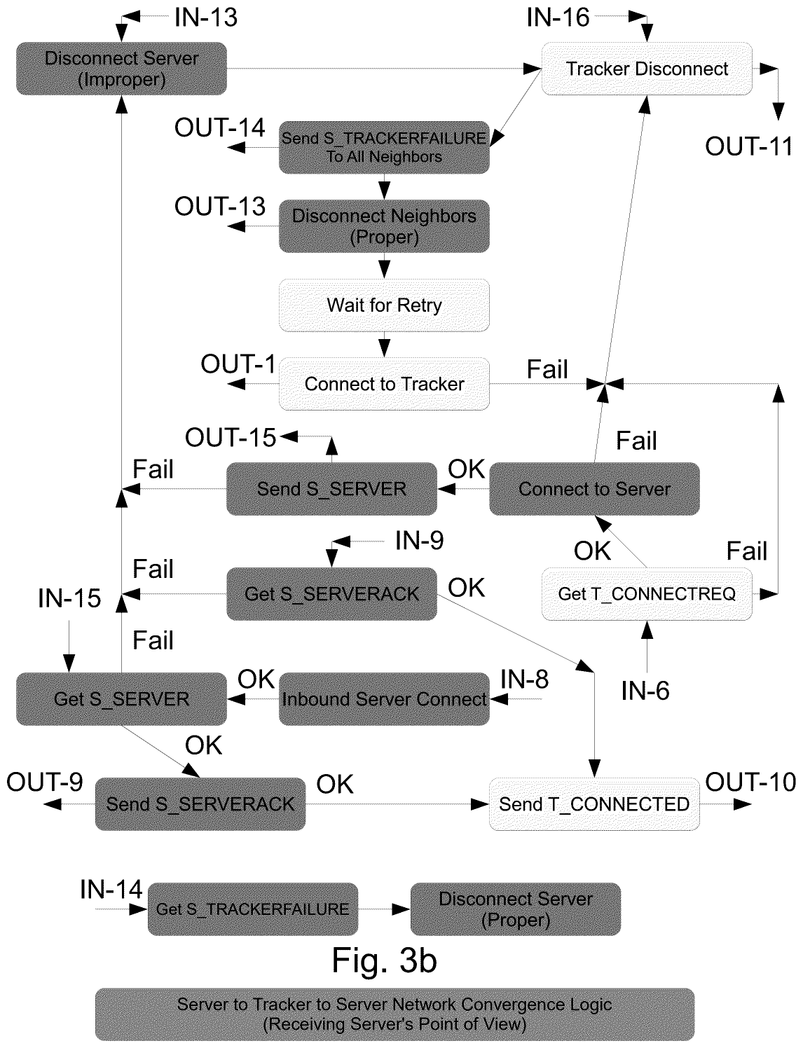

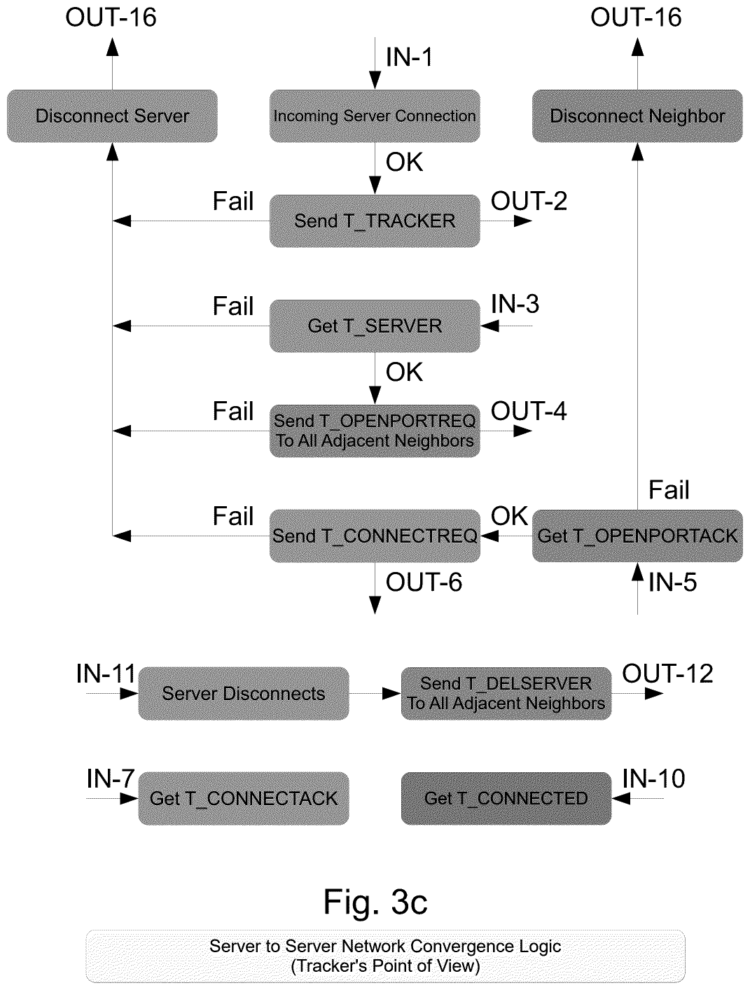

FIGS. 3a, 3b and 3c are communication flow diagrams. The outward facing arrows labeled with OUT-n connect to corresponding inward facing arrows labeled with In-n. FIG. 3a is depicted from a connecting server's point of view. FIG. 3b is depicted from a receiving server's point of view. FIG. 3c is depicted from the tracker's point of view.

Server coordinates are functions of the in-game player coordinate system. They are an implementation of the coordinate summary addresses described in U.S. Pat. No. 10,188,952 entitled Method for Dynamically Mapping servers issued Jan. 29, 2019, the entire contents of which are incorporated herein by reference thereto. This document describes a third dimensional in-game coordinate system using 32 bit unsigned integers for the X, Y and Z axes. The examples used here will assume a coordinate summary address width of /20,/20,/20. Using these parameters each server has an internal address space of 4096*4096*4096 addresses. This naturally makes the server space in the shape of a cube. This is true of all servers that use the same bit-width on the X, Y and Z axis. Other configurations will result in various other rectangular shapes.

A basic necessary function is to convert in-game world coordinates to network server coordinate addresses. This is done by performing a right bit shift to the players in-game coordinates on every axis. The coordinates are shifted right by the total axis integer length less the width of the network coordinate address on the respective axis. The pseudo code for this is as follows. Let “wcoord” be the in-game world coordinate and “ncoord” be the server coordinate.

```
n_coord_wcoord_to_ncoord(w_coord wcoord) {
  n_coord ncoord;
  wcoord_width.x = 32; ncoord_width.x = 20;
  wcoord_width.y = 32; ncoord_width.y = 20;
  wcoord_width.z = 32; ncoord_width.z = 20;
  ncoord.x = wcoord.x >> (wcoord_width.x − ncoord_width.x);
  ncoord.y = wcoord.y >> (wcoord_width.y − ncoord_width.y);
  ncoord.z = wcoord.z >> (wcoord_width.z − ncoord_width.z);
  return ncoord;
}
```

In addition there needs to be a function to test for network server coordinate equality. It returns 1 for true and 0 for false. If the X, Y and Z coordinates are equal then true is returned. Otherwise false is returned.

```
int ncoord_is_equal(n_coord a, n_coord b) {
  if ((a.x == b.x) && (a.y == b.y) && (a.z == b.z))
    return 1;
  return 0;
}
```

The ranging functions are used to determine if two servers are close enough to interact with each other. The terms “center server” and “side server” are relative terms. A server refers to itself as a “center server”. All neighboring servers are referred to as “side servers”. The “center” server address is compared against a “side” server address. Only servers that are in range of each other connect to each other. This implementation uses a “reach” of 1 server which creates a 3 by 3 by 3 (27) set of servers. A “reach” of 2 would create a 5 by 5 by 5 (125) set of servers. The center server address is first checked that it obeys the global network boundaries. The same check is then performed on the side server address. The edges of the global address space can also be wrapped but that is not shown here. We then check to see if the side server address is in range of the center server address.

```
int serv_in_range_of_serv(n coord center, n_coord side) {
  int reach = 1;
  if ((center.x < LATTICE_NXMIN) ||
    (center.x > LATTICE_NXMAX)) return 0;
  if ((center. y < LATTICE_NYMIN) ||
    (center.y > LATTICE_NYMAX)) return 0;
  if ((center.z < LATTICE_NZMIN) ||
    (center.z > LATTICE_NZMAX)) return 0;
  if ((side.x < LATTICE_NXMIN) ||
    (side.x > LATTICE_NXMAX)) return 0;
  if ((side.y < LATTICE_NYMIN) ||
    (side. y > LATTICE_NYMAX)) return 0;
  if ((side.z < LATTICE_NZMIN) ||
    (side.z > LATTICE_NZMAX)) return 0;
  if ((side.x < center.x − reach) ||
    (side.x > center.x + reach)) return 0;
  if ((side.y < center.y − reach) ||
    (side.y > center.y + reach)) return 0;
  if ((side.z < center.z − reach) ||
    (side.z > center.z + reach)) return 0;
  return 1;
}
```

We can now use the equality and ranging functions to check whether or not a center server is allowed to communicate with a side server. If the center and side are the same address false is returned. If the side is in range of the center true is returned, otherwise false is returned.

```
int serv_can_connect_to_serv(n_coord center, n_coord side) {
  if (ncoord_is_equal(center, side)) return 0;
  return serv_in_range_of_serv (center, side);
}
```

The connectivity checking function can be called by a server to check its own neighbor connectivity abilities.

int serv_can_connect_to_me (n_coord coord) {
return serv_can_connect_to_serv (my_coord, coord);
}

Having described the basic functions, a neighbor table can be constructed for each server in the terms of the geometry of the network. All servers have a neighbor table that reflects their own relative position in the network. The table is used to communicate with geometrically neighboring servers. It is not a global table. Servers only need to be aware of their adjacent neighboring servers. The neighbor table itself is a third dimensional array of 27 (3*3*3) pointers to socket structures that hold all the necessary information about individual neighboring servers.

By comparing the remote server network address to the local network address a position in the table can be determined.

```
server_socket *find_neighbor (n_coord coord) {
  int a,b,c;
  if (!serv_can_cannect_to_me(coord)) return NULL;
  a = coord.x − my_coord.x + reach;
  b = coord.y − my_coord.y + reach;
  c = coord.z − my_coord.z + reach;
  return neighbor_table[a][b][c];
}
```

### Tracker

holds global tables of servers
maps server coordinates to IPs and ports
coordinates server to server connectivity

The tracker has a full view of the server's in-game locations and thus overall network geometry. It uses this information to orchestrate flat Euclidean geometric connectivity between the servers. Servers are given the information needed to connect to any neighboring servers that might be bordering them. This document describes an implementation of a network that requires all servers to be of the same size. In a third dimensional example this would be all the geometric contacts on the 6 two dimensional sides, the 12 one dimensional edges and the 8 zero dimensional corners. This yields a maximum of 26 (3*3*3-1) neighboring servers.

Convergence is achieved through processes that represent two opposing forces. They are the constructive force and destructive force. For any given configuration of servers there will only be one final state of convergence. These two forces facilitate this final state.

The rules for constructive convergence are as follows.
A server with no tracker connection will connect to the tracker after a timeout delay.
If the tracker tells a server to connect to a neighbor it must.
If the tracker tells a server to prepare for an inbound neighbor connection it must.

The rules for destructive convergence are as follows.
A server with no tracker connection must have no neighbor connections.
A server that cannot honor the tracker connect requests must disconnect from the tracker.
A server that cannot honor the tracker inbound neighbor connection request must disconnect from the tracker.

It is the server's responsibility to maintain the structure of the network that the tracker dictates to it. This prevents the network from getting into a state where the two servers are next to each other but are disconnected from each other.

It is the trackers responsibility to inform all servers of the status of their individual neighbor servers. All live changes to the network must be immediately propagated to the appropriate neighbor servers. The tracker must ensure that no two servers occupy the same network position at the same time. It must also ensure that all servers connect to only servers that are adjacent to themselves. This ensures that the space remains flat and is not bent into impossible shapes.

The servers, tracker and players interact using prefixes, for example, the following:
CS=Connecting Server
NS=Neighbor Servers
T=Tracker
LC=Local Clients

The system as a whole provides a Homogeneous Coordinate Summary Network Structure. The coordinates may comprise a /20/20/20 coordinate system, representing 20 bits for each of the X, Y and Z directions.

The servers, tracker and players interact via summary communications that utilize Convergence Sequences, as follows:

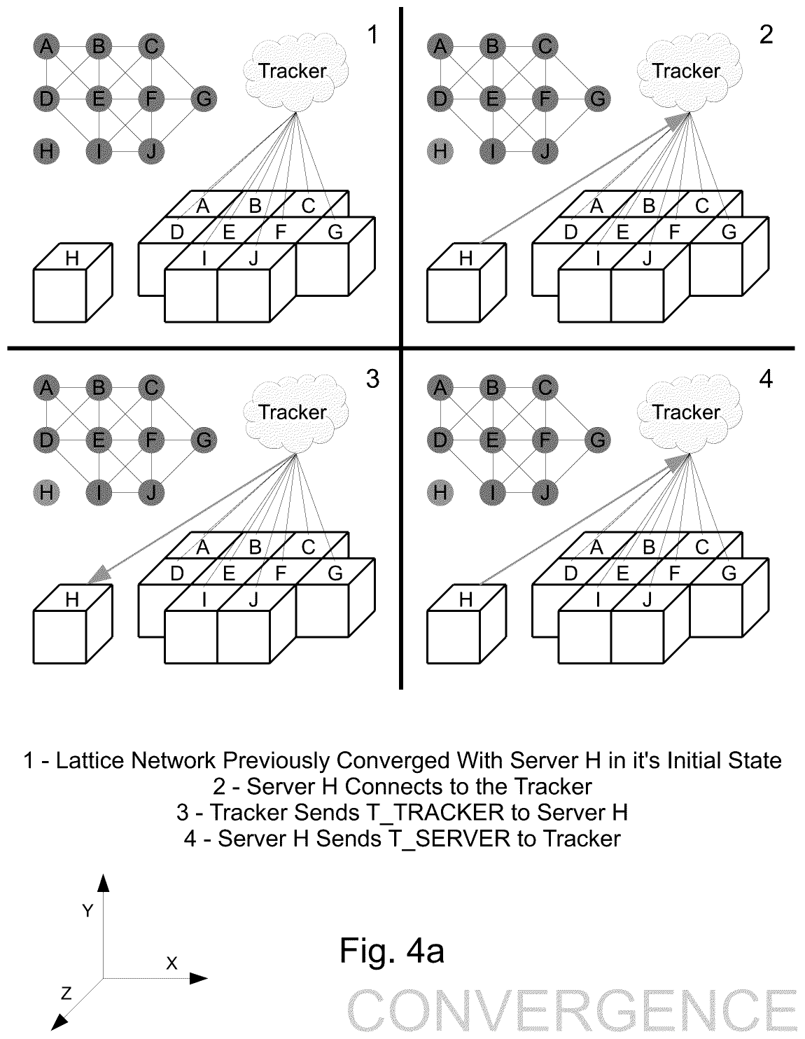

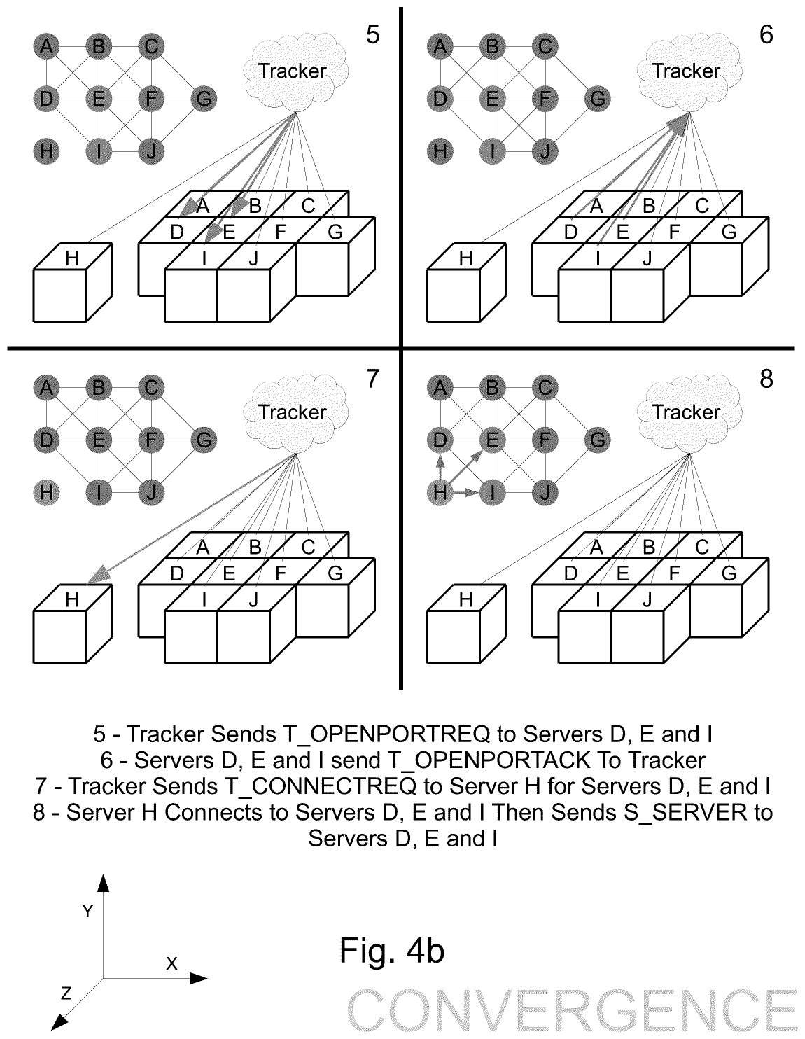

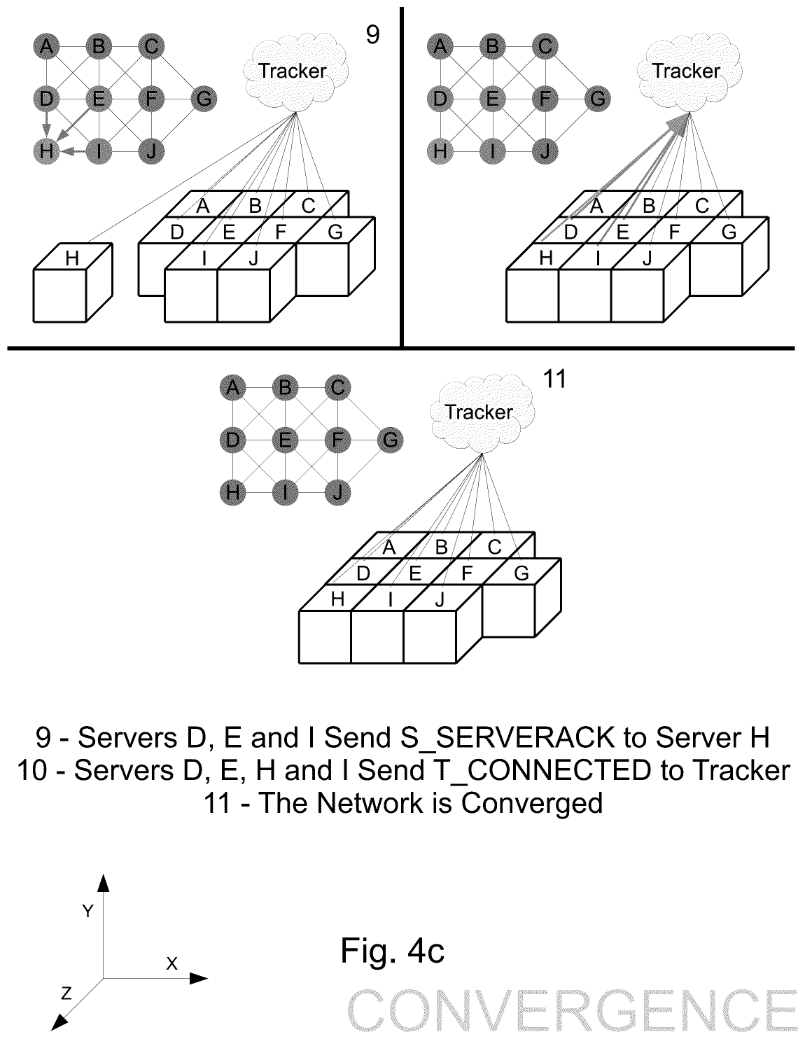

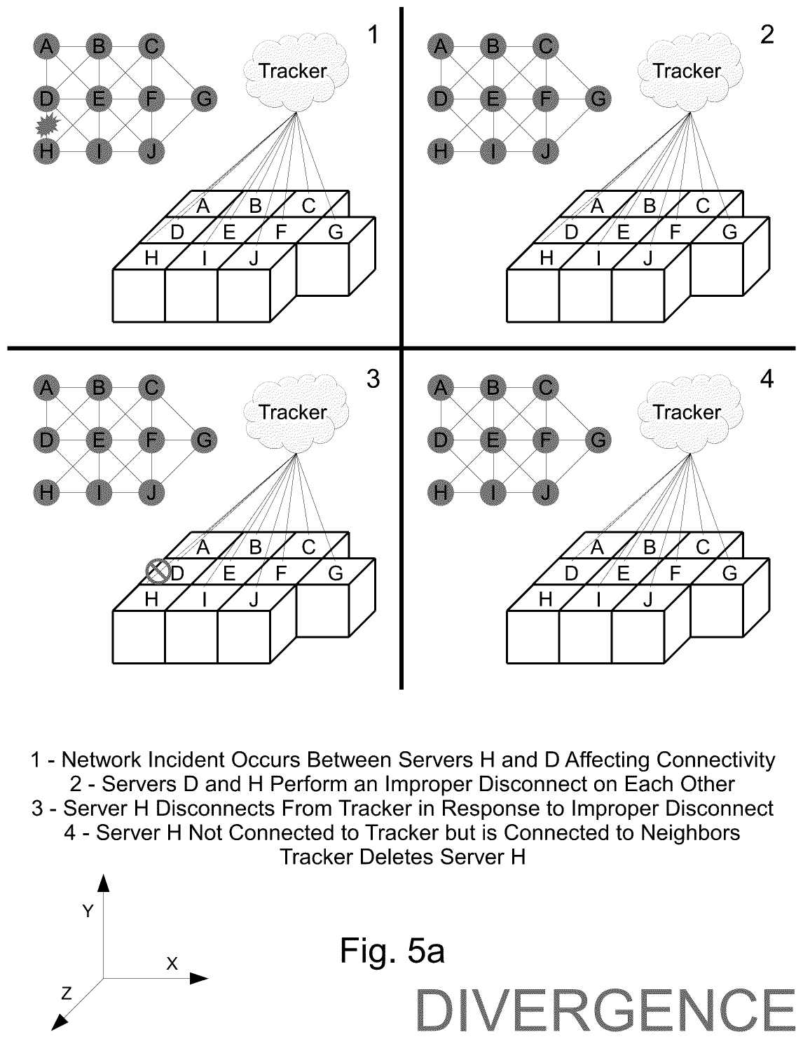

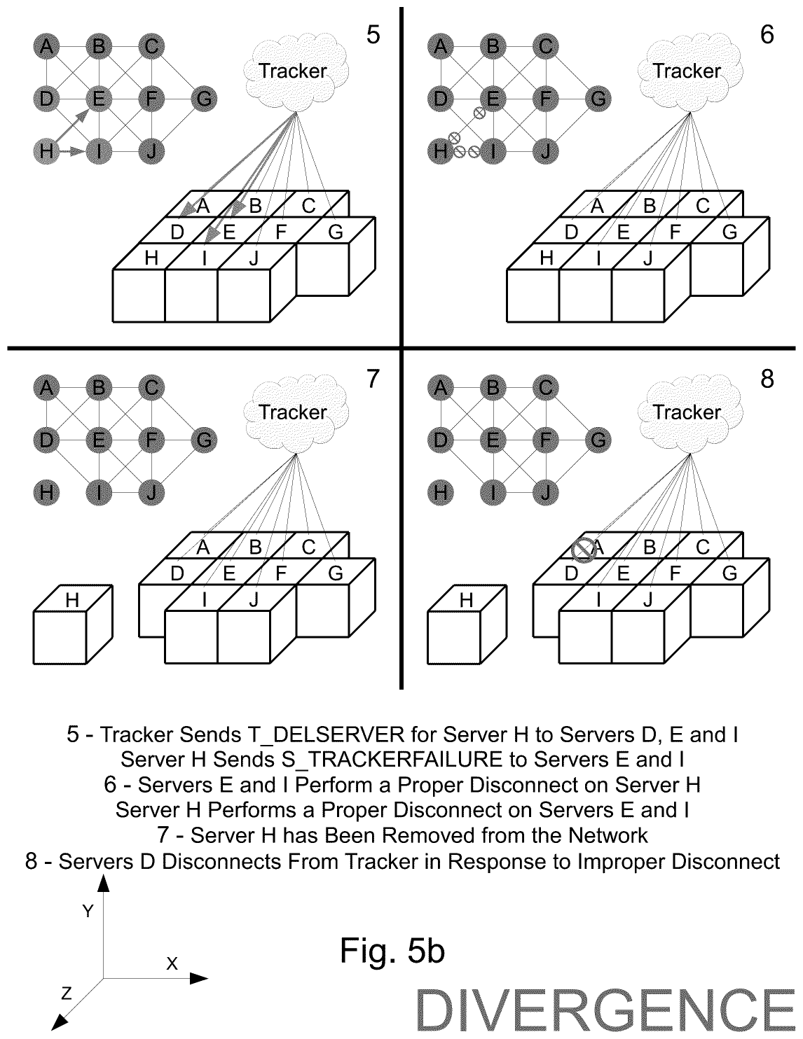

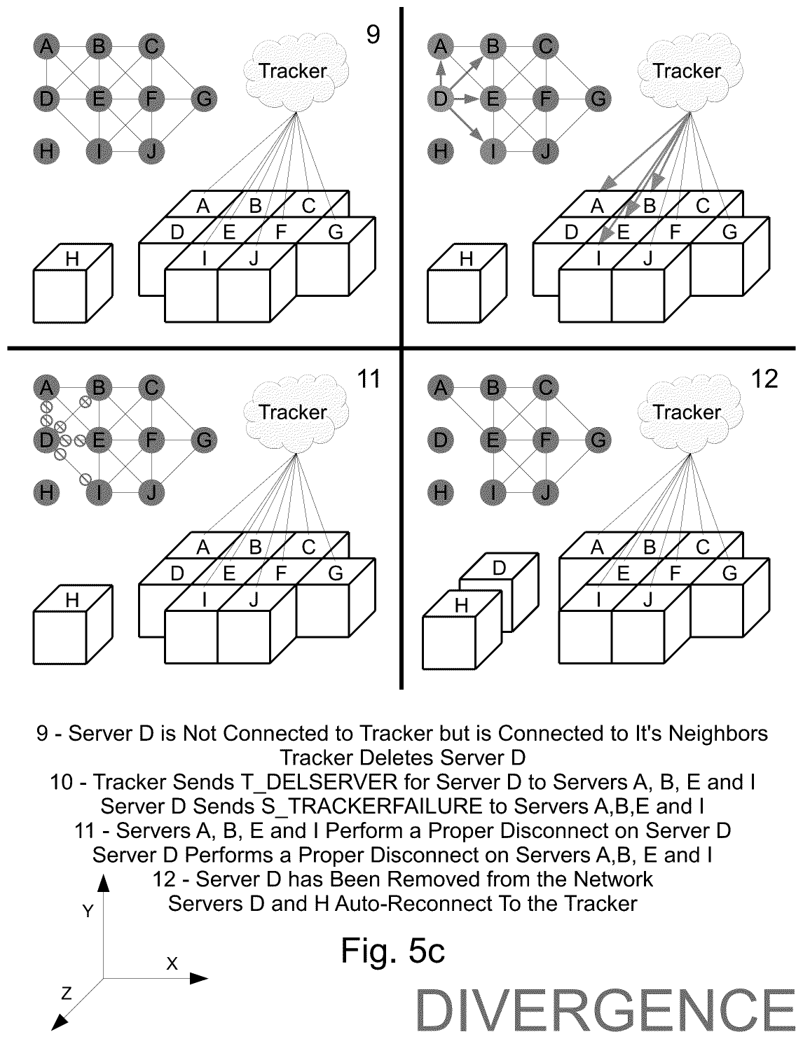

The initial disconnected state is shown in FIG. 4a-1.
S1:1-CS->T (connect) (FIG. 4a-2)
S1:2-CS<-T [T_TRACKER] IP Port SatStep Version (FIG. 4a-3)
S1:3-CS->T [T_SERVER] CS-X CS-Y CS-Z IP ServerPort ClientPort Version (FIG. 4a-4)
S1:4-CS X-T CS-X CS-Y CS-Z collision (tracker disconnects connecting server, go to S1)
S1:5-NS<-T [T_OPENPORTREQ] CS-X CS-Y CS-Z IP ServerPort ClientPort (FIG. 4b-5)
S1:6-NS-X T no ports available (neighbor disconnects tracker, go to S1)
S1:7-NS->T [T_OPENPORTACK] CS-X CS-Y CS-Z IP ServerPort ClientPort (FIG. 4b-6)
S1:8-CS<-T [T_CONNECTREQ] NS-X NS-Y NS-Z IP ServerPort ClientPort (FIG. 4b-7)
S1:9-CS->NS (connect)
S1:10-CS->NS [S_SERVER] CS-X CS-Y CS-Z IP ServerPort ClientPort (FIG. 4b-8)
S1:11-CS->T [T_CONNECTACK] NS-X NS-Y NS-Z IP ServerPort ClientPort
S1:12-CS->LC [C_SERVER] NS-X NS-Y NS-Z IP ClientPort
S1:13-NS->CS [S_SERVERACK] NS-X NS-Y NS-Z IP ServerPort ClientPort (FIG. 4c-9)
S1:14-NS->T [T_CONNECTED] CS-X CS-Y CS-Z IP ServerPort ClientPort (FIG. 4c-10)
S1:15-NS->LC [C_SERVER] CS-X CS-Y CS-Z IP ClientPort
S1:16-CS->T [T_CONNECTED] NS-X NS-Y NS-Z IP ServerPort ClientPort (FIG. 4c-10)

In Sequence 1 Step 1 [S1:1], the Connecting Server connects to the Tracker. (FIG. 4a-2)

In S1:2, the Tracker uses the T_TRACKER command to inform the connecting server of its IP Port, SatStep and Version. The SatStep specifies the length of a day in the game. The servers use this coupled with UTC time to determine the position of the sun or moon in the sky with consistency across all the servers on the network. (FIG. 4a-3)

In S1:3, the Connecting Server responds to the tracker's T_TRACKER with a T_SERVER command. This command conveys the Connecting Server's network coordinate summary address with the corresponding IP address and port numbers of the server along with the server's version number. (FIG. 4a-4)

In S1:4, the Tracker identifies another server is already located at the Connecting Server's network location coordinate. This causes the Tracker to disconnect the Connecting Server.

In S1:5, the Tracker has verified that the servers network location coordinate is unique. It then sends Open Port Requests to the all the Neighboring Servers. The Open Port Requests contain the Connecting Server's network coordinate summary address with the corresponding IP address and port numbers of the server. The Connecting Server's network coordinate summary address is used to locate the position in the Neighboring Server's internal socket table. (FIG. 4b-5)

In S1:6, the Neighboring Server cannot honor the port request. Since this would cause network desynchronization the Neighboring Server must disconnect from the tracker.

In S1:7, the Neighboring Server honors the Open Port Request and responds to the Tracker with an Open Port Acknowledgment. The Open Port Acknowledgment contain the Connecting Server's network coordinate summary address with the corresponding IP address and port numbers of the server. (FIG. 4b-6)

In S1:8, the Tracker responds to the Neighboring Servers Open Port Acknowledgment by sending a Connect Request to the Connecting Server. The Connect Request contains the Neighboring Server's network coordinate summary address with the corresponding IP address and port numbers of the server. (FIG. 4b-7)

In S1:9, the Connecting Server connects to the Neighboring Server.

In S1:10, the Connecting Server sends a Server Statement to the Neighboring Server. The Server Statement contains the Connecting Server's network coordinate summary address with the corresponding IP address and port numbers of the server. (FIG. 4b-8)

In S1:11, the Connecting Server sends a Connection Acknowledgment to the Tracker. The Connection Acknowledgment contains the Neighboring Server's network coordinate summary address with the corresponding IP address and port numbers of the server.

In S1:12, the Connecting Server sends a Server Statement to its Local Clients. The Server Statement contains the Neighboring Server's network coordinate summary address with the corresponding IP address and client port number of that server.

In S1:13, the Neighboring Server responds to the Connecting Server's Server Statement in S1:10 with a Server Acknowledgment. The Server Acknowledgment contains the Neighboring Server's network coordinate summary address with the corresponding IP address and port numbers of that server. (FIG. 4c-9)

In S1:14, the Neighboring Server sends a Connected Statement to the Tracker. The Connected Statement contains the Connecting Server's network coordinate summary address with the corresponding IP address and port numbers of that server. (FIG. 4c-10)

In S1:15, the Neighboring Server sends a Server Statement to its Local Clients. The Server Statement contains the Connecting Server's network coordinate summary address with the corresponding IP address and client port number of that server.

In S1:16, the Connecting Server responds to the Neighboring Server's Server Acknowledge in S1:13 by sending a Connected Statement to the Tracker. The Connected Statement contains the Neighboring Server's network coordinate summary address with the corresponding IP address and port numbers of that server. (FIG. 4c-10)

The network follows divergence sequences when it cannot maintain the network structure that the tracker dictates.
DS1=Disconnecting Server 1
DS2=Disconnecting Server 2
NS=Neighbor Servers
T=Tracker

The initial connected state is shown in FIG. 4c-11.
S2:1-DS1 X-NS (unexpected disconnect) (FIGS. 5a-1 and 2)
S2:2-DS1-X T (disconnect tracker) (FIGS. 5a-3 and 4)
S2:3-DS1->NS [S_TRACKERFAILURE] (FIG. 5b-5)
S2:4-NS<-T [T_DELSERVER] DS1-X DS1-Y DS1-Z (FIG. 5b-5)
S2:5-DS1-X NS (disconnect neighbor) (FIGS. 5b-6 and 7)
S2:6-DS2-X T (disconnect tracker) (FIGS. 5b-8 and 5c-9)
S2:7-DS2->NS [S_TRACKERFAILURE] (FIG. 5c-10)
S2:8-NS<-T [T_DELSERVER] DS2-X DS2-Y DS2-Z (FIG. 5c-10)
S2:9-DS2-X NS (disconnect neighbor) (FIGS. 5c-11 and 12)

In Sequence 2 Step 1 [S2:1], Disconnecting Server 1 unexpectedly disconnects from a Neighbor Server. (FIGS. 5a-1 and 2)

In S2:2, Disconnecting Server 1 disconnects from the Tracker. (FIGS. 5a-3 and 4)

In S2:3, Disconnecting Server 1 uses the S_TRACKERFAILURE command to inform the Neighboring Server(s) that it disconnected from the Tracker. (FIG. 5b-5)

In S2:4, the Tracker uses the T_DELSERVER command to inform the Neighboring Server(s) that they must disconnect from Disconnecting Server 1. (FIG. 5b-5)

In S2:5, Disconnecting Server 1 and the Neighboring Server(s) must disconnect from each other. (FIGS. 5b-6 and 7)

In S2:6, Disconnecting Server 2 disconnects from the Tracker. (FIGS. 5b-8 and 5c-9)

In S2:7, Disconnecting Server 2 uses the S_TRACKERFAILURE command to inform the Neighboring Server(s) that it disconnected from the Tracker. (FIG. 5c-10)

In S2:8, the Tracker uses the T_DELSERVER command to inform the Neighboring Server(s) that they must disconnect from Disconnecting Server 2. (FIG. 5c-10)

In S2:9, Disconnecting Server 2 and the Neighboring Server(s) must disconnect from each other. (FIGS. 5c-11 and 12)

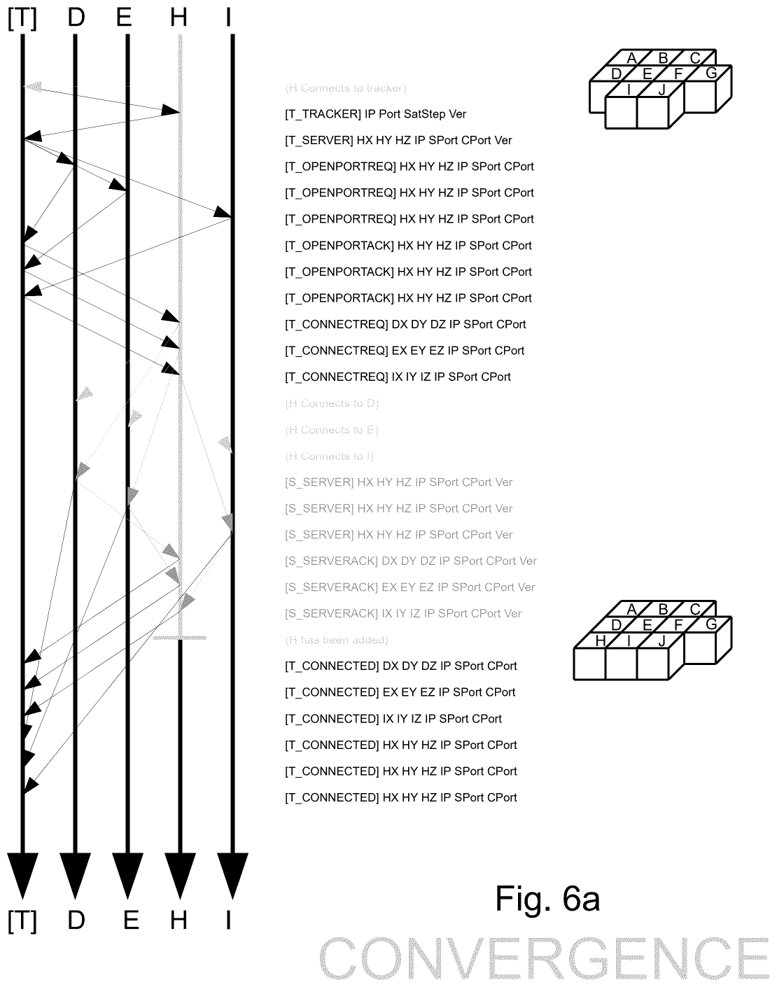

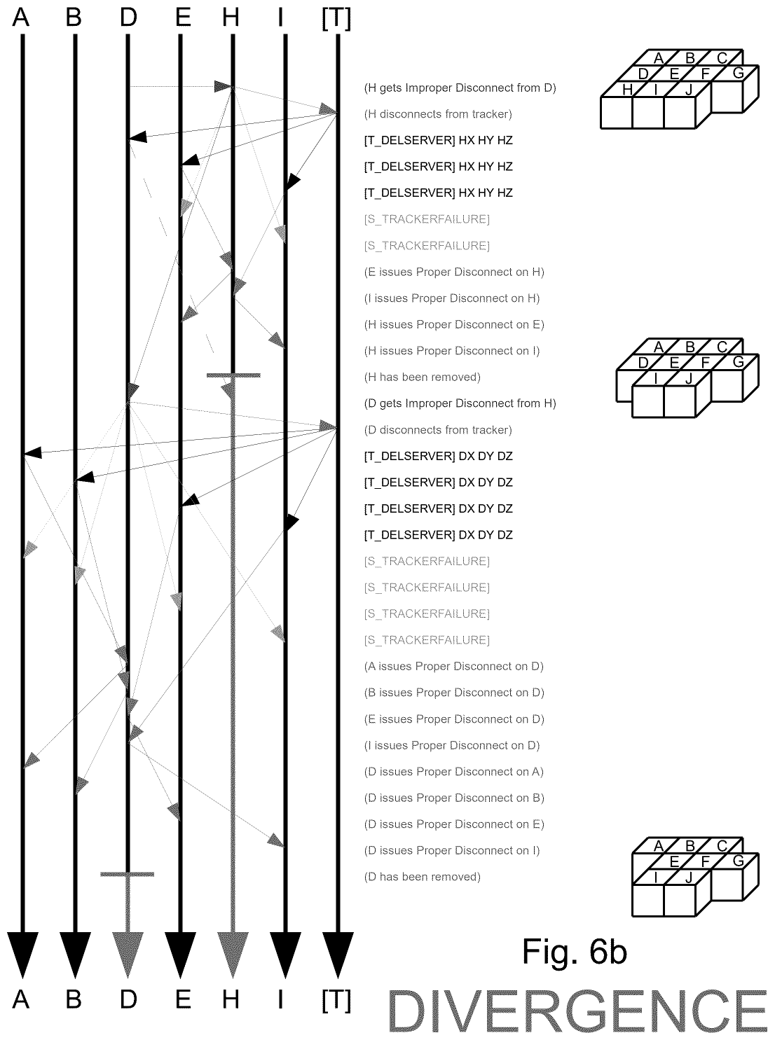

FIGS. 6a and 6b are communication time line diagrams. They are read from top to bottom. FIG. 6a is a convergence event and FIG. 6b is a divergence event.

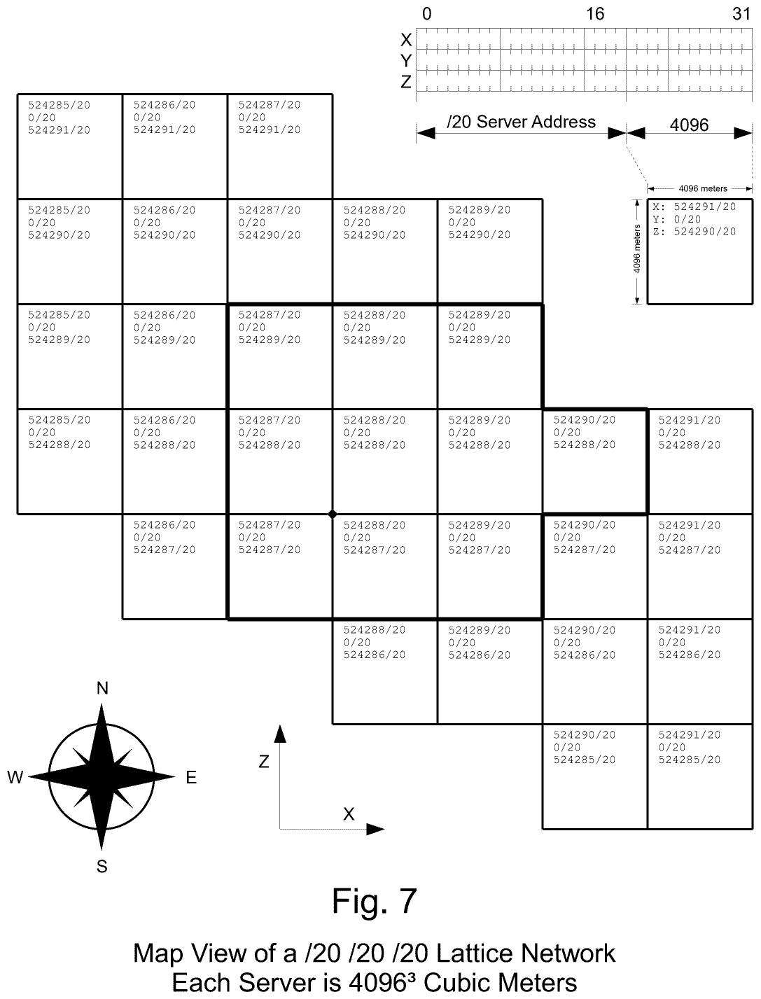

FIG. 7 shows an example of server coordinates in various locations within the game.
When moving between areas from west to east, the X (first) coordinate increments.
When moving between areas from south to north, the Z (third) coordinate increments.

In this example, the Y coordinate is always 0, representing the players location on the ground, i.e. without elevation.

### Technical Implementation

### General Protocol Specification

An example of a lattice network protocol is specified here. There is a general purpose static packet header that is used for encapsulation of information. The payload type and length are part of this header. The header contains the following six fields.
Field 1: (uint32) Synchronization Marker

Description: This field is used to detect loss of synchronization. If the field is not what the receiving side expects it to be then packet alignment has been lost. This triggers a disconnection.
Field 2: (uint32) Source User Identification

Description: This field is used predominantly for client connections which are beyond the scope of this document.
Field 3: (uint16) Flags

Description: This field is used predominantly for client connections which are beyond the scope of this document.
Field 4: (uint16) Payload Type

Description: This indicates what type of payload this packet header encapsulates. The payload type integer corresponds to command names which govern function execution on the receiving side.
Field 5: (uint32) Payload Argument Count

Description: This indicates how many arguments will be passed in the payload.
Field 6: (uint32) Payload Length

Description: This is the length of the payload. It is used to determine the start position of the next packet.

### Tracker Protocol Specification

The following is an example of the Tracker Protocol commands.
Command: T_UNKNOWN (0)
   Direction: Server to Tracker or Tracker to Server
   Argument Count: 0
Command: T_TRACKER (1)
   Direction: Tracker to Server
   Argument Count: 4
      Argument 1: (string) IP Address
      Argument 2: (uint16) Port Address
      Argument 3: (uint32) Satellite Step
      Argument 4: (string) Version
Command: T_OPENPORTREQ (2)
   Direction: Tracker to Server
   Argument Count: 6
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port
Command: T_CONNECTREQ (3)
   Direction: Tracker to Server
   Argument Count: 6
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port
Command: T_DELSERVER (4)
   Direction: Tracker to Server
   Argument Count: 3
      Argument 1: (int32) Server X Coordinate
      Argument 2: (int32) Server Y Coordinate
      Argument 3: (int32) Server Z Coordinate
Command: T_PING (5)
   Direction: Server to Tracker or Tracker to Server
   Argument Count: 0
Command: T_PONG (6)
   Direction: Server to Tracker or Tracker to Server
   Argument Count: 0
Command: T_SERVER (7)
   Direction: Server to Tracker
   Argument Count: 7
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port
      Argument 7: (string) Version
Command: T_OPENPORTACK (8)
   Direction: Server to Tracker
   Argument Count: 6
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port
Command: T_CONNECTACK (9)
   Direction: Server to Tracker
   Argument Count: 6
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port
Command: T_CONNECTED (10)
   Direction: Server to Tracker
   Argument Count: 6
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port

### Server Protocol Specification

The following is an example of the Server Protocol commands.
Command: S_UNKNOWN (0)
   Direction: Any Server to Any Server
   Argument Count: 0
Command: S_SERVER (1)
   Direction: Connecting Server to Neighboring Server
   Argument Count: 7
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port
      Argument 7: (string) Version
Command: S_SERVERACK (2)
   Direction: Neighboring Server to Connecting Server
   Argument Count: 7
      Argument 1: (int32) Server X Coordinate
      Argument 2: (int32) Server Y Coordinate
      Argument 3: (int32) Server Z Coordinate
      Argument 4: (string) IP Address
      Argument 5: (uint16) Server Port
      Argument 6: (uint16) Client Port
      Argument 7: (string) Version
Command: S_KILL (3)
   Direction: Any Server to Any Server
   Argument Count: 3
      Argument 1: (uint32) User ID
      Argument 2: (uint32) Numeric
      Argument 3: (string) Reason
Command: S_TRACKERFAILURE (4)
   Direction: Any Server to Any Server
   Argument Count: 0
Command: S_PING (5)
   Direction: Any Server to Any Server
   Argument Count: 0
Command: S_PONG (6)
   Direction: Any Server to Any Server
   Argument Count: 0
Command: S_CLOSING (7)
   Direction: Any Server to Any Server
   Argument Count:
      Argument 1: (uint32) Numeric
      Argument 2: (string) Reason

Having described preferred embodiments of self-assembling geometric networks (which are intended to be illustrative and not limiting), it is noted that modifications and variations can be made by persons skilled in the art in light of the above teachings. For example, the coordinate addressing system can accommodate locations at various elevations, i.e. where Y represents a value other than zero. The coordinate addresses may have a smaller or larger number of bits to accommodate differently scaled networks. For example, a /21,/20,/21 server occupies exactly one quarter the volume of a /20,/20,/20 server. It is the same height (Y axis) as the /20,/20,/20 server however it is half the length on the X and Z axis resulting in a quarter of the land space. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

1. A virtual environment game network system comprising:
area servers that store neighboring portions of the virtual environment;
a tracker having a table of area servers expressed as coordinate network addresses which map to internet IP addresses;
a global communications system which allows said area servers and said tracker to communicate with each other; and
a non-transitory computer readable medium including a program of instructions for assembling the area servers into a seamless virtual game environment that when executed by a computer performs the steps of:
connecting said area servers to said tracker over the global communications system;
determining the connectivity status of said area servers to identify accessible area servers; and
convergence sequencing one of said accessible area servers to assemble its portion of the virtual environment adjacent to a neighboring portion of the virtual environment stored on another one of said accessible area servers thereby providing a homogeneous coordinate network to seamlessly access any coordinate address within the converged virtual environment.

2. The game network system of claim 1, wherein said convergence sequencing step includes:
providing a homogeneous coordinate network to seamlessly access any previously sequenced coordinate address within the converged virtual environment.

3. The game network system of claim 1, wherein the coordinate network address comprises X, Y, Z three-axis position coordinates that specify a location within the neighboring portion; and a coordinate network summary address containing the position coordinates bit-shifted by the corresponding axis integer length minus the width of the network coordinate address.

4. The game network system of claim 3, wherein said determining step includes identifying area servers that have coordinate network summary addresses that vary by one bit in one axis thereby sequencing the area servers for adjacent pairing in the convergence sequencing step.

5. The game network system of claim 4, wherein each area server has a neighbor table including an identification of other area servers that have coordinate network summary addresses that vary by one bit in one axis thereby defining a neighboring area server and a pointer to a socket that contains network reachability information for accessing neighboring area servers.

6. The game network system of claim 5, wherein said determining step includes:
determining by the tracker the connectivity status of said area servers to identify accessible area servers to populate the table of area servers.

7. The game network system of claim 6, wherein the tracker extracts from the table of area servers and communicates to each area server an identification of other area servers that have coordinate network summary addresses that vary by one bit in one axis.

8. The game network system of claim 7, wherein said tracker maps area server position coordinates to Internet Protocol (IP) Addresses and ports to provide direct addressing to spatially-distributed area servers.

9. The game network system of claim 3, wherein said determining step includes assigning a negative connectivity status to an area server if its coordinate network summary address is already in use by an assembled area server.

10. The game network system of claim 9, wherein determining the connectivity status of an area server includes requesting a port from a neighboring area server.

11. The game network system of claim 10, wherein said determining step includes assigning a negative connectivity status to an area server if a neighboring area server denies a port request.

12. The game network system of claim 3, wherein a convergence sequenced area server is a Neighboring Area Server and a divergence sequenced area server is a Connecting Area Server, and wherein said tracker coordinates convergence sequencing of said Connecting Area Server to said Neighboring Area Server.

13. The game network system of claim 12, wherein said connecting step includes:
said tracker communicating its IP Port to a Connecting Area Server (S1:2); and
said Connecting Area Server responding with its coordinate network summary address, IP Address and port numbers (S1:3).

14. The game network system of claim 13, wherein said connecting step further includes:
said tracker sending an Open Port Request to said Neighboring Area Server including said Connecting Area Server's coordinate network summary address, IP Address and port numbers, wherein said Connecting Area Server's coordinate network summary address is used to determine the position in the Neighboring Server's internal socket table (S1:5);
the Neighboring Server honors the Open Port Request and responds with an Open Port Acknowledgment containing the Connecting Area Server's coordinate network summary address, IP address and port numbers (S1:7); and
said tracker replies to the Neighboring Area Server by sending a Connect Request to the Connecting Area Server containing the Neighboring Area Server's coordinate network summary address, IP address and port numbers (S1:8).

15. The game network system of claim 14, wherein said convergence sequencing step includes:
the Connecting Area Server sends a Server Statement to the Neighboring Area Server containing the Connecting Area Server's coordinate network summary address, IP address and port numbers (S1:10);
the Connecting Area Server sends a Connection Acknowledgment to the tracker containing the Neighboring Area Server's coordinate network summary address, IP address and port numbers (S1:11);
the Connecting Area Server sends a Server Statement to its Local Clients containing the Neighboring Area Server's coordinate network summary address, IP address and port numbers (S1:12); and
the Neighboring Area Server responds to the Connecting Area Server's Server Statement with a Server Acknowledgment containing the Neighboring Area Server's coordinate network summary address, IP address and port numbers (S1:13).

16. The game network system of claim 15, wherein said convergence sequencing step further includes:
the Neighboring Area Server sends a Connected Statement to the tracker containing the Connecting Area Server's coordinate network summary address, IP address and port numbers (S1:14);
the Neighboring Area Server sends a Server Statement to its Local Clients containing the Connecting Area Server's coordinate network summary address, IP address and port numbers (S1:15); and
the Connecting Area Server responds to the Neighboring Area Server's Server Acknowledgment by sending a Connected Statement to the tracker containing the Neighboring Area Server's coordinate network summary address, IP address and port numbers (S1:16).

17. The game network system of claim 12, wherein said disconnecting step includes:
the Disconnecting Area Server disconnecting from said tracker (S2:2);
the Disconnecting Area Server communicating the failure to the Neighboring Area Servers by sending a Tracker Failure Statement (S2:3);
the tracker responding to the Disconnecting Area Server by sending the Neighboring Area Servers a Delete Server Statement (S2:4); and
the Disconnecting Area Server disconnecting the Neighboring Area Servers (S2:5).

18. The game network system of claim 1, wherein the area servers all store neighboring portions of the same size.
